(19) United States
(12) Patent Application Publication
(10) Pub. No.: US 2005/0037727 A1
(43) Pub. Date: Feb. 17, 2005

(54) Method and apparatus for controlling a sleep mode within a communications system

(76) Inventors: Vivek Kansal, Randolph, NJ (US); Ramabadran S. Raghavan, Flanders, NJ (US)

Correspondence Address: WILLIAMS, MORGAN & AMERSON/LUCENT, 10333 RICHMOND, SUITE 1100, HOUSTON, TX, 77042, US

(21) Appl. No.: 10/627,092

(22) Filed: Jul. 25, 2003

(51) Int. Cl. H04B 1/38

(52) U.S. Cl. 455/343.1; 455/343.4; 455/561

(57) ABSTRACT

An apparatus that may be comprised of a processor and one or more components for supporting communication over at least a first and a second channel in a communications system is provided. The processor may be adapted to monitor a parameter associated with at least one of the first and second channels, and to place at least one of the components in a sleep mode in response to detecting a preselected aspect of the monitored parameter.

### BACKGROUND OF THE INVENTION

1. Field of the Invention

This invention relates generally to a communications system, and, more particularly, to providing a power saving mode of operation for a portion of the communications system.

2. Description of the Related Art

In the field of wireless telecommunications, such as cellular telephony, a system typically includes a plurality of base stations distributed within an area to be serviced by the system. Various users within the area, fixed or mobile, may then access the system and, thus, other interconnected telecommunications systems, via one or more of the base stations. Typically, a mobile user maintains communications with the system as the user passes through an area by communicating with one and then another base station, as the user moves. The user may communicate with the closest base station, the base station with the strongest signal, the base station with a capacity sufficient to accept communications, etc.

Commonly, each base station is constructed to process a plurality of communications sessions with a plurality of users over a plurality of channels or carrier frequencies. The number of carrier frequencies assigned to a base station is typically a function of the number of users expected to access the base station, which may be affected by traffic patterns, the number of nearby base stations, time of day, day of the week, holidays, and the like. All other things being equal, the larger the number of channels, the more users the base station can handle. The users typically select one of the identified carrier frequencies and then attempt to initiate a communications session with the base station. If the session fails or is refused by the base station, the user may attempt other available frequencies until a session is initiated or the list of possible carrier frequencies is exhausted.

One notable shortcoming to systems of this type is that the number of carrier frequencies assigned to a base station may be selected based upon peak conditions. For example, a base station located near a major highway may be required to handle a large volume of communications sessions during, for example, rush hour traffic. To ensure that users are able to readily communicate with the system during high-usage times, a base station may be assigned a relatively large number of carrier frequencies. An inadequate number of carrier frequencies may result in a significant number of failed communications sessions, producing unhappy customers. Those skilled in the art will appreciate that, all other things being equal, generally the larger the number of carrier frequencies, the greater the power consumed by the base station.

Power consumption, however, is not directly related to the number of communications sessions being handled by the base station. That is, power consumption may remain relatively high even if relatively few communications sessions are being handled by the base station. Thus, even during off-peak or relatively low usage times, the base station consumes substantial power, a significant portion of which may be wasted.

Additionally, electronic equipment used in a base station has a useful life that is linked, at least in part, to the amount of time that the equipment is powered on. Accordingly, a substantial portion of the equipment's useful life may be consumed by long periods of time in which it handles few, or no, communications sessions.

The present invention is directed to overcoming, or at least reducing, the effects of one or more of the problems set forth above.

### SUMMARY OF THE INVENTION

In one aspect of the instant invention, a method for controlling a communications system is provided. A parameter associated with the communications system may be monitored. At least one component of the communications system may be requested to enter a sleep mode in response to detecting a preselected aspect of the monitored parameter.

In another aspect of the instant invention, a communications system is provided. The communications system may be comprised of a first channel, a second channel, and a controller. The controller may be adapted to monitor a parameter associated with at least one of the first and second channels, and to place at least one of the first and second channels in a sleep mode in response to detecting a preselected aspect of the monitored parameter.

In still another aspect of the instant invention, a method for controlling a communications system is provided. The method comprises monitoring a parameter associated with the communications system, and requesting at least one channel of a plurality of channels associated with the communications system to enter a sleep mode in response to detecting a preselected aspect of the monitored parameter.

In yet another aspect of the instant invention, an apparatus is provided. The apparatus may be comprised of a processor and one or more components for supporting communication over at least a first and a second channel in a communications system. The processor may be adapted to monitor a parameter associated with at least one of the first and second channels, and to place at least one of the components in a sleep mode in response to detecting a preselected aspect of the monitored parameter.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a data communications system, in accordance with one embodiment of the present invention;

FIG. 2 depicts a block diagram of one embodiment of the communications system of FIG. 1;

FIG. 3 is a block diagram of one embodiment of at least a portion of a base station of the type that may be employed in the communications systems of FIGS. 1 and 2;

FIGS. 4 and 5 illustrate flowcharts of methods that may be implemented by one or more components of the communications systems of FIGS. 1, 2 and 3, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

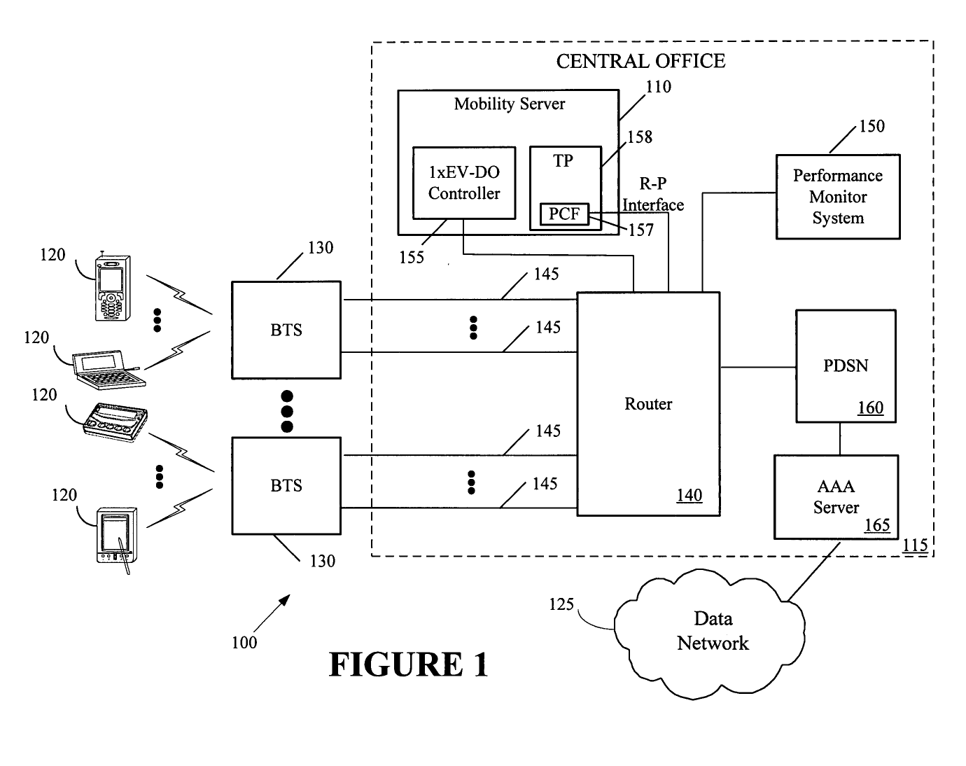

Turning now to the drawings, and specifically referring to FIG. 1, a communications system 100 is illustrated, in accordance with one embodiment of the present invention. For illustrative purposes, the communications system 100 of FIG. 1 is a 1xEV-DO system, although it should be understood that the present invention may be applicable to other systems that support data and/or voice communication. For example, the instant invention may find application in a wide variety of wireless environments, such as 3GIX CDMA, IS95B, GSM GPRS, UMTS, DECT, AMPS, EDGE, TDMA or other similar wireless applications.

In the illustrated embodiment, the communications system 100 includes a mobility server 110 located at a central office 115 that allows one or more access terminals 120 to communicate with a data network 125, such as the Internet, through one or more base stations (BTS) 130. The access terminal 120 may include one of a variety of devices capable of accessing voice, video and/or data services, including cellular phones, personal digital assistants (PDAs), laptops, digital pagers, wireless cards, and any other device capable of accessing the data network 125 through the BTS 130.

In one embodiment, each BTS 130 may be coupled to a router 140 by one or more connections 145, such as T1/E1 lines or circuits, ATM circuits, cables, and optical digital subscriber lines (DSLs). In the illustrated embodiment, the communications system 100 includes a performance monitor (PM) system 150 that allows a user, such as a service provider, to monitor a variety of useful information in substantially real-time. For example, the PM system 150 may monitor the load, and hence the load balance, of the connections 145 (e.g., T1/E1 circuits) of the BTS 130, the service data rate of one or more access terminals 120, and/or the service data rate of each sector supported by the BTS 130. It should be understood that the act of monitoring information in “real-time” may involve the inherent delays associated with transmitting, receiving, and displaying the information. As such, “real-time” information may be monitored in “substantially” real-time. A service provider, based on the real-time information, can analyze the performance of the selected components of the communications system 100 to troubleshoot communication problems, to identify a load associated with a particular BTS 130, to identify how many communications sessions are being handled by each BTS 130, as well as to determine if the operation of selected components should be altered to support the current data traffic load.

The mobility server 110 of FIG. 1 generally provides replication, communications, runtime, and system management services. The mobility server 110, in the illustrated embodiment, includes a 1xEV-DO controller 155, and a packet control function (PCF) module 157 embedded in a traffic processor (TP) module 158. The 1xEV-DO controller 155 supports 1xEV-DO service in the communications system 100 of FIG. 1, and the traffic processor module 158 handles calling processing functions, such as setting and terminating a call path. The traffic processor module 158, in one embodiment, is capable of determining a data transmission rate on the forward and/or reverse link for each user (or access terminal 120) and for each sector supported by the BTS 130. The PCF module 157, in one embodiment, buffers data received from a packet data service node (PDSN) 160 (described below), as well as maintains data during the dormant state. The PCF module 157 may support communications through an Open R-P (A10-A11) interface, where the A10 interface may be utilized for packet traffic and the A11 interface for signaling. Because the Open R-P interface is well-known to those skilled in the art, it is not described in detail herein.

In the illustrated embodiment, the PDSN 160 is coupled between the router 140 and an Authentication, Authorization, and Accounting (AAA) server 165. The PDSN 160 generally establishes secure communications to the access terminal 120 through security information provided by the AAA server 165. In one embodiment, the PDSN 160 records data usage, receives accounting information from the PCF module 157 over the Open R-P (A10-A11) interface, correlates the data to generate the accounting information, and relays the correlated information to the AAA server 165. The PDSN 160 may also maintain a serving list and a unique link layer identifier for the access terminals 120.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

It should be understood that the configuration of the communications system 100 of FIG. 1 is exemplary in nature, and that fewer or additional components may be employed in other embodiments of the communications system 100. For example, in one embodiment, the system 100 may include a network management system (not shown) that provides operation, administration, maintenance, and provisioning functions for a 1XEV-DO network. Additionally, the system 100 may include one or more multiplexers (not shown) connected between the BTS 130 and the router 140 for performing protocol translations. In one embodiment, the PDSN 160 may be coupled to the data network 125 without the AAA server 165. Similarly, other components may be added or removed from the communications system 100 of FIG. 1 without deviating from the spirit and scope of the invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

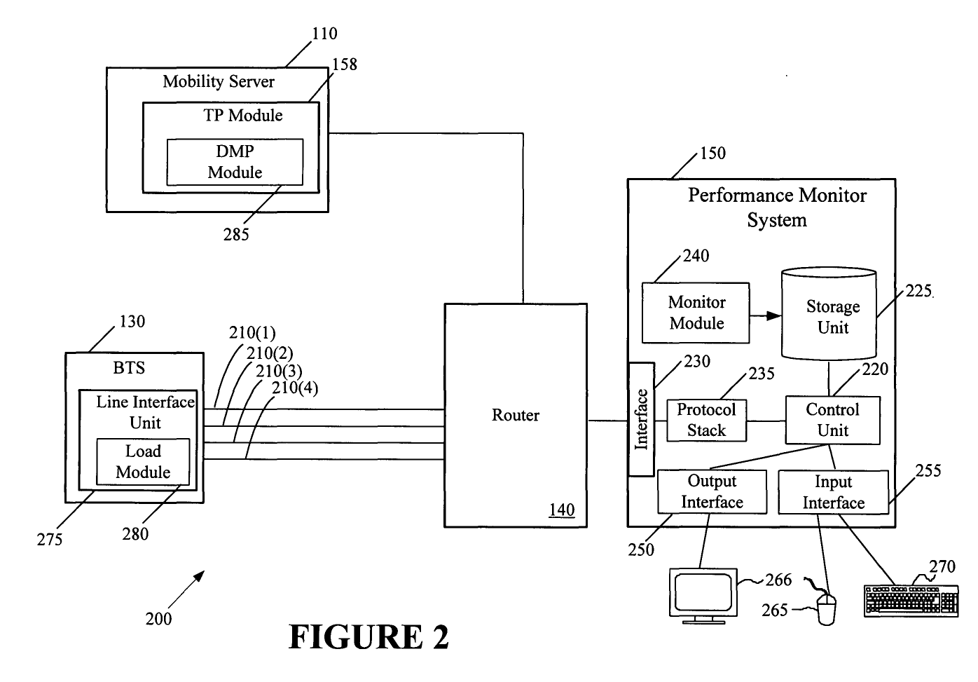

Referring now to FIG. 2, a block diagram of one embodiment of a communications system 200 is illustrated, in accordance with one embodiment of the present invention. The system 200 includes the PM system 150 coupled to the router 140. In the illustrated embodiment, the router 140 is further coupled to the BTS 130 by four T1 circuits (or lines) 210(1-4). For ease of illustration, only one BTS 130 is illustrated, although it should be understood that the communications system 200 may include more than one BTS 130.

The PM system 150 includes a control unit 220 that is communicatively coupled to a storage unit 225. The PM system 150 also includes a network interface 230 that provides the communications interface to the router 140. Associated with the network interface 230 may be a network protocol stack 235, with one example being a UDP/IP (User Datagram Protocol/internet Protocol) stack. UDP is described in RFC 768, entitled “User Datagram Protocol,” dated August 1980. In another embodiment, the network protocol stack 235 may be a Transmission Control Protocol/Internet Protocol (TCP/IP) stack. In one embodiment, both inbound and outbound packets may be passed through the network interface 230 and the network protocol stack 235.

The PM system 150 includes a monitor module 240 that is storable in the storage unit 225. The monitor module 240 is capable of providing requests and receiving data via the network interface 230. In one embodiment, the monitor module 240 allows a user to monitor, in substantially real-time, the load of each T1 circuit 210(1-4) in the BTS 130, the service data rate of one or more access terminals 120 (see FIG. 1) that access the data network 125 through the BTS 130, and/or the service data rate of each sector that is supported by the BTS 130.

In one embodiment, the PM system 150 includes an output interface 250 and an input interface 255. The output interface 250 may be capable of interfacing with a display device 266 to display information thereon. The input interface 255 may be capable of interfacing with input devices, such as a mouse 265 and/or a keyboard 270, to allow a user to input information into the PM system 150.

The BTS 130 includes a line interface unit 275 and a load module 280. The load module 280, in the illustrated embodiment, receives requests from the monitor module 240 of the PM system 150 and responds to the requests through the line interface unit 275. The monitor module 240, for example, may request the load module 280 to provide the data traffic on (or bandwidth usage of) one or more of the T1 circuits 210(1-4). The amount of data traffic may be determined, in one embodiment, by calculating a volume of data packets transmitted over a particular T1 circuit 210 at a given time or a given period. The exchange of information between the monitor module 240 and the load module 280 may occur over TCP/IP or UDP/IP. If the communications system 200 includes more than one BTS 130, then, in one embodiment, each BTS 130 may include the load module 280 to provide load information for its respective T1 circuits 210. The number of T1 circuits 210 supported by a given BTS 130 may vary from one BTS 130 to another.

In the illustrated embodiment, the traffic processor module 158 of the mobility server 110 includes a data manager processor (DMP) module 285 that receives requests from, and responds to, the monitor module 240 of the PM system 150 over an open network protocol, such as TCP/IP or UDP/IP. The monitor module 240, for example, may request the DMP module 280 to provide the data transmission rate on a user basis or a sector basis.

The various components of the communications system 200 of FIG. 2, such as the PM system 150 and the mobility server 110, may be coupled to the router 140 in a variety of suitable ways, including over an Ethernet network, ATM connection, Token Ring network, or any other connection capable of supporting the Internet Protocol.

It should be understood that the configuration of the communications system 200 of FIG. 2 is exemplary in nature, and that a variety of other configurations may be employed in other embodiments. For example, in one embodiment, the monitor module 240 may be implemented in one of the access terminals 120 (see FIG. 1), and, as such, the user of the access terminal 120 may wirelessly access information such as the load on one or more of the T1 circuits 210, the data rate for a given user(s), and/or the data rate for a given sector(s). Additionally, in an alternate configuration, the PM system 150 may receive load information regarding one or more of the T1 circuits 210 from the mobility server 110 rather than from the BTS 130.

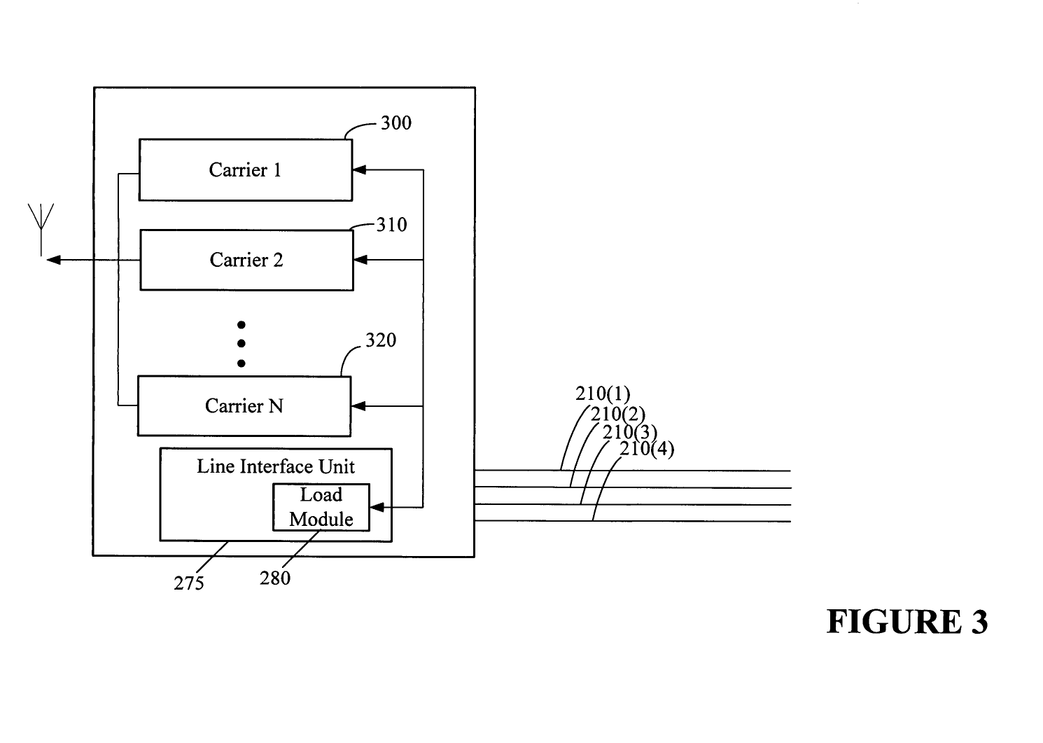

Referring now to FIG. 3, a block diagram illustrating the structural and functional components of at least a portion of an exemplary BTS 130 is shown. In the illustrated embodiment, the BTS 130 is comprised of a plurality of carrier frequencies or channels, 300, 310, 320 configured to communicate with one or more of the access terminals 120. The number of carrier frequencies or channels 300, 310, 320 affects the number of access terminals 120 that may effectively communicate with the data network 125 via the BTS 130. That is, all other things being equal, the more carrier frequencies or channels, the more access terminals 120 that may be supported by an individual BTS 130. Accordingly, it is typical for a BTS 130 located at a relatively high-traffic area to be configured with a larger number of carrier frequencies or channels, whereas a BTS 130 located at a relatively low-traffic area is configured with a smaller number of carrier frequencies or channels.

It will be appreciated that the number of carrier frequencies or channels required by a BTS 130 to adequately support the access terminals 120 in its area may vary over time. That is, fewer carrier frequencies or channels may be required late at night, as compared to during rush hour. Further, as development and market share vary, so too may the demand on a particular BTS 130. Accordingly, in the embodiment illustrated in FIG. 3, the various carrier frequencies or channels 300, 310, 320 may be selectively enabled/disabled to more closely tailor the capacity of the BTS 130 to its current needs. For example, the load module 280 may be configured to disable selected carrier frequencies or channels after a preselected time in the evening, or the load module 280 may monitor the actual traffic at the BTS 130 and selectively enable/disable carrier frequencies or channels to accommodate the current load. In this manner, the BTS 130 is allowed to enter into a “sleep mode” and thereby conserve power and operating life.

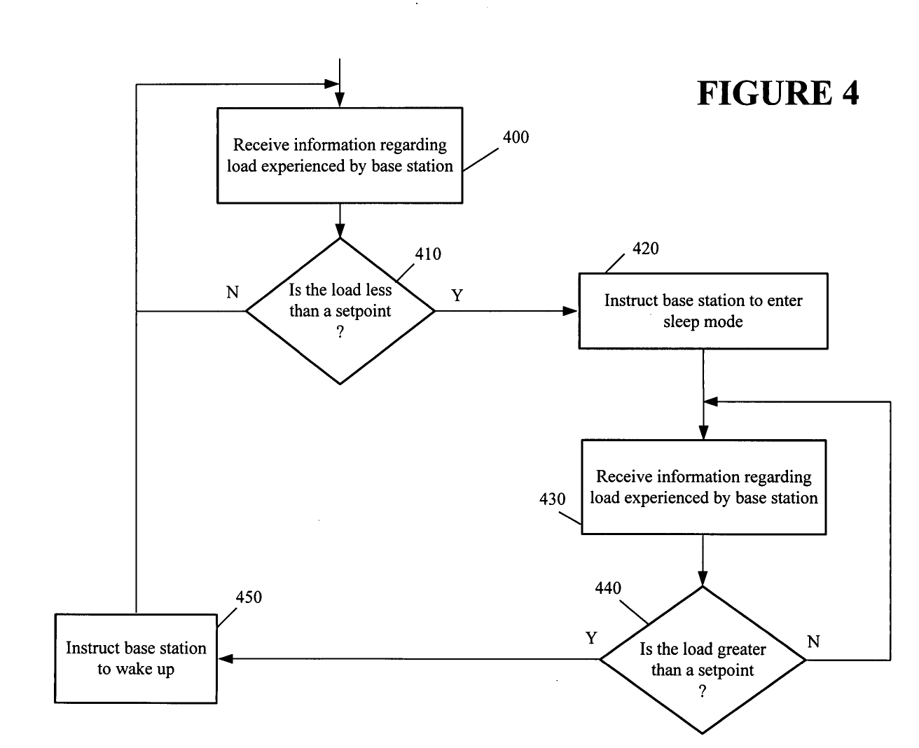

Turning now to FIG. 4, one embodiment of a flowchart representation of a method that may be performed by the load module 280 is illustrated. Those skilled in the art will appreciate that the method of FIG. 4 may be implemented using software, hardware, or a combination thereof without departing from the spirit and scope of the instant invention. Additionally, the method described in conjunction with FIG. 4 may be performed in alternative embodiments by other components within the communications systems 100, 200 without departing from the spirit and scope of the instant invention. For example, some or all of the methodology of FIG. 4 may be performed by the mobility server 110, the router 140, and the PM system 150 or by a separate but interconnected device (not shown). Further, within the mobility server 110, some or all of the methodology of FIG. 4 may be performed by the DMP module 285. Likewise, within the PM system 150, some or all of the methodology of FIG. 4 may be performed by the monitor module 240.

During the operation of the system 100, a software routine may be called or executed to perform the methodology represented in FIG. 4. The process begins at block 400 with the receipt of information regarding the load experienced by the BTS 130. The load experienced by the BTS 130 may be determined by monitoring any of a plurality of factors. For example, the load may be determined as a function of the number of access terminals 120 or by the amount of data being transmitted to the BTS 130 over each channel. Alternatively, the load may be determined by the aggregate amount of data or number of access terminals 120 relative to all active channels. Additionally, load may be determined as a function of both the individual cumulative channels.

At block 410, the information regarding the current load experienced by the BTS 130 is compared to a first preselected setpoint. If the load remains relatively high, the BTS 130 remains in a normal mode of operation and control returns to the block 400. On the other hand, if the load is relatively low, then the BTS 130 may be instructed to enter a sleep mode to conserve power (420). The sleep mode may take on any of a variety of forms. For example, the BTS 130 may enter a sleep mode by disabling or reducing the functionality of one or more of its channels. In one embodiment, the BTS 130 may remove or reduce an operating voltage that is normally supplied to hardware circuitry responsible for transmitting and receiving signals over one or more of the channels within the BTS 130. While the BTS 130 is in the sleep mode, the BTS 130 will, at least temporarily, cease to use those channels that have been disabled.

Once the BTS 130 has entered the sleep mode, the control routine again monitors load to determine if the BTS 130 should be awakened and all, or at least partial, functionality restored to the channels that have been shut down. Accordingly, at block 430 information regarding the load experienced by the base station 130 is again received. At block 440 the load information is compared to a second preselected setpoint to determine whether to awaken at least some of the channels. If the load remains relatively low, control returns to block 420 where the load information is again monitored and the process repeats until the detected load rises above the second preselected setpoint. In some embodiments, it may be useful to set the first and second setpoints at different values. For example, setting the second preselected setpoint at a value higher than the first preselected setpoint may introduce a hysteresis that may be useful to prevent the BTS 130 from oscillating between the normal and sleep modes of operation. That is, once the BTS 130 enters the sleep mode, the load will have to increase substantially before the disabled channels are awakened. Thus, once the load has risen above the second preselected setpoint, control transfers to block 450 and the BTS 130 is brought out of the sleep mode, restoring the channels to full functionality.

In an alternative embodiment, it may be useful to have multiple first and second setpoints so that the BTS 130 may be progressively put to sleep and then progressively awakened. For example, as the load falls, progressively more channels may be disabled, and then as load rises, progressively more channels may be awakened. In this manner, the capacity of the BTS 130 may be closely matched to the current communications needs of the access terminals 120.

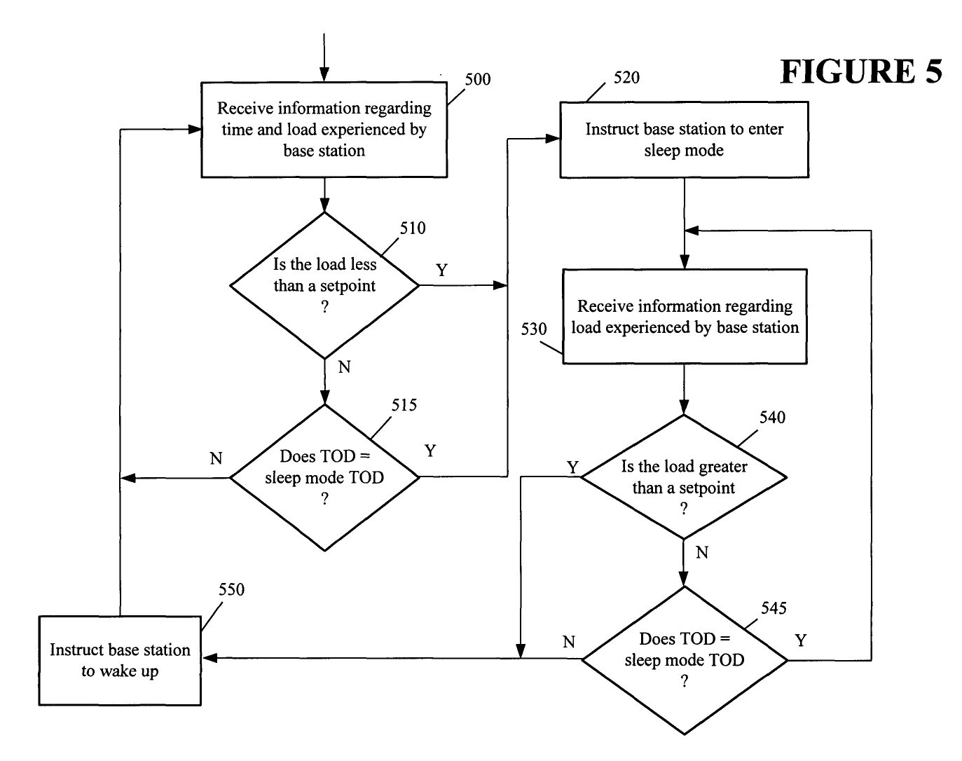

Turning now to FIG. 5, it may be useful to consider time-of-day (TOD), as well as load, in determining whether certain channels of the BTS 130 should be placed in the sleep mode. For example, the process begins at block 500 with the receipt of information regarding the load experienced by the BTS 130. At block 510, the information regarding the current load experienced by the BTS 130 is compared to a first preselected setpoint. If the load remains relatively high, the BTS 130 remains in a normal mode of operation and control returns to the block 500. On the other hand, if the load is relatively low, then the BTS 130 may be instructed to enter a sleep mode to conserve power (520).

Once the BTS 130 has entered the sleep mode, the control routine monitors load and time-of-day (TOD) to determine if the BTS 130 should be awakened and all, or at least partial, functionality restored to the channels that have been shut down. Accordingly, at block 530 information regarding the load experienced by the base station 130 is again received. At block 540 the load information is compared to a second preselected setpoint to determine whether to awaken at least some of the channels. If the load rises above the second preselected setpoint, control transfers to block 550 and the BTS 130 is brought out of the sleep mode, restoring one or more of the channels to full functionality. On the other hand, if the load remains relatively low, control passes to decision block 545 where the TOD is compared to a sleep mode TOD. If the current TOD is still within the sleep mode TOD, then control returns to block 530 where the load information is again monitored and the process repeats. If, however, the current TOD is outside the sleep mode TOD, then control also transfers to block 550 where the BTS 130 is brought out of the sleep mode. In this manner, the BTS 130 is awakened in anticipation of heavier load.

Those skilled in the art will appreciate that other combinations of load and TOD may be used to put the BTS 130 in, and awaken it from, sleep mode without departing from the spirit and scope of the instant invention. For example, in some embodiments, it may be useful to rely solely on TOD in determining whether the BTS 130 should be placed in sleep mode.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions of the described method and system may be implemented in different locations, such as the wireless unit, the base station, a base station controller and/or mobile switching center. Moreover, processing circuitry required to implement and use the described method and system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

1. A method for controlling a communications system, comprising:
monitoring a parameter associated with the communications system; and
requesting at least one component of the communications system to enter a sleep mode in response to detecting a preselected aspect of the monitored parameter.

2. A method, as set forth in claim 1, wherein monitoring the parameter associated with the communications system further comprises monitoring time of day and wherein requesting at least one component of the communications system to enter the sleep mode in response to detecting the preselected aspect of the monitored parameter further comprises requesting at least one component of the communications system to enter the sleep mode in response to the time of day being later than a first preselected setpoint.

3. A method, as set forth in claim 2, further comprising requesting at least one component of the communications system leave the sleep mode in response to detecting a preselected aspect of the monitored parameter.

4. A method, as set forth in claim 3, wherein requesting at least one component of the communications system leave the sleep mode in response to detecting a preselected aspect of the monitored parameter further comprises requesting at least one component of the communications system leave the sleep mode in response to the time of day being later than a second preselected setpoint.

5. A method, as set forth in claim 3, wherein monitoring the parameter associated with the communications system further comprises monitoring load associated with at least one component of the communications system and wherein requesting at least one component of the communications system leave the sleep mode in response to detecting a preselected aspect of the monitored parameter further comprises requesting at least one component of the communications system leave the sleep mode in response to the monitored load being greater than a preselected setpoint.

6. A method, as set forth in claim 1, wherein monitoring the parameter associated with the communications system further comprises monitoring load associated with at least one component of the communications system and wherein requesting at least one component of the communications system to enter the sleep mode in response to detecting the preselected aspect of the monitored parameter further comprises requesting at least one component of the communications system to enter the sleep mode in response to the monitored load being less than a preselected setpoint.

7. A method, as set forth in claim 1, wherein monitoring the parameter associated with the communications system further comprises monitoring load and time of day associated with at least one component of the communications system and wherein requesting at least one component of the communications system to enter the sleep mode in response to detecting the preselected aspect of the monitored parameter further comprises requesting at least one component of the communications system to enter the sleep mode in response to the monitored load being less than a preselected setpoint and the time of day being later than a preselected setpoint.

8. A method, as set forth in claim 1, wherein requesting at least one component of the communications system to enter the sleep mode in response to detecting the preselected aspect of the monitored parameter further comprises requesting that at least one component of the communications system to enter a low-power consumption mode in response to detecting the preselected aspect of the monitored parameter.

9. A method, as set forth in claim 1, wherein requesting at least one component of the communications system to enter the sleep mode in response to detecting the preselected aspect of the monitored parameter further comprises requesting at least one channel of a plurality of channels associated with the communications system to enter the sleep mode.

10. A method, as set forth in claim 9, wherein requesting at least one channel of the plurality of channels associated with the communications system to enter the sleep mode in response to detecting the preselected aspect of the monitored parameter further comprises requesting a first channel of the plurality of channels associated with the communications system to enter the sleep mode in response to detecting a first preselected aspect of the monitored parameter and requesting a second channel of the plurality of channels associated with the communications system to enter the sleep mode in response to detecting a second preselected aspect of the monitored parameter.

11. A method, as set forth in claim 10, wherein requesting the first channel of the plurality of channels associated with the communications system to enter the sleep mode in response to detecting the first preselected aspect of the monitored parameter further comprises requesting the first channel of the plurality of channels associated with the communications system to enter the sleep mode in response to detecting the monitored parameter falling below a first preselected parameter and wherein requesting the second channel of the plurality of channels associated with the communications system to enter the sleep mode in response to detecting the second preselected aspect of the monitored parameter further comprises requesting the second channel of the plurality of channels associated with the communications system to enter the sleep mode in response to detecting the monitored parameter falling below a second preselected parameter.

12. A method, as set forth in claim 1, wherein requesting at least one component of the communications system to enter the sleep mode in response to detecting the preselected aspect of the monitored parameter further comprises disabling at least one channel of a plurality of channels associated with the communications system.

13. A method, as set forth in claim 1, wherein requesting at least one component of the communications system to enter the sleep mode in response to detecting the preselected aspect of the monitored parameter further comprises disabling at least one channel of a plurality of channels associated with the communications system.

14. An apparatus, for controlling a communications system, comprising:
means for monitoring a parameter associated with the communications system; and
means for requesting at least one component of the communications system to enter a sleep mode in response to detecting a preselected aspect of the monitored parameter.

15. A communications system, comprising:
a first channel;
a second channel; and
a controller adapted to monitor a parameter associated with at least one of the first and second channels, and to place at least one of the first and second channels in a sleep mode in response to detecting a preselected aspect of the monitored parameter.

16. A method for controlling a communications system, comprising:
monitoring a parameter associated with the communications system; and
requesting at least one channel of a plurality of channels associated with the communications system to enter a sleep mode in response to detecting a preselected aspect of the monitored parameter.

17. A method, as set forth in claim 16, wherein monitoring the parameter associated with the communications system further comprises monitoring time of day and wherein requesting at least one channel of the plurality of channels associated with the communications system to enter the sleep mode in response to detecting the preselected aspect of the monitored parameter further comprises requesting at least one at least one channel of the plurality of channels associated with the communications system to enter the sleep mode in response to the time of day being later than a first preselected setpoint.

18. A method, as set forth in claim 17, further comprising requesting at least one at least one channel of the plurality of channels associated with the communications system leave the sleep mode in response to detecting a preselected aspect of the monitored parameter.

19. A method, as set forth in claim 18, wherein requesting at least one channel of the plurality of channels associated with the communications system leave the sleep mode in response to detecting the preselected aspect of the monitored parameter further comprises requesting at least one channel of the plurality of channels associated with the communications system leave the sleep mode in response to the time of day being later than a second preselected setpoint.

20. A method, as set forth in claim 18, wherein monitoring the parameter associated with the communications system further comprises monitoring load associated with at least one channel of the plurality of channels associated with the communications system and wherein requesting at least one channel of the plurality of channels associated with the communications system leave the sleep mode in response to detecting the preselected aspect of the monitored parameter further comprises requesting at least one channel of the plurality of channels associated with the communications system leave the sleep mode in response to the monitored load being greater than a preselected setpoint.

21. An apparatus, comprising:
one or more components for supporting communication over at least a first and a second channel in a communications system; and
a processor adapted to monitor a parameter associated with at least one of the first and second channels, and to place at least one of the components in a sleep mode in response to detecting a preselected aspect of the monitored parameter.
